(19) United States
(12) Patent Application Publication
(10) Pub. No.: US 2009/0222232 A1
(43) Pub. Date: Sep. 3, 2009

(54) REEL MOTOR TORQUE CALIBRATION DURING TAPE MOTION

(75) Inventors: Kempton Redhead, Fountain Valley, CA (US); Yoshitomi Koike, Ehime-Ken (JP); John Sverida, Dana Point, CA (US); Umang Mehta, Irvine, CA (US); Junichi Hyogo, Matsuyama (JP)

Correspondence Address: BAKER BOTTS L.L.P., 2001 ROSS AVENUE, SUITE 600, DALLAS, TX, 75201-2980, US

(73) Assignees: Quantum Corporation, San Jose, CA (US); Panasonic Shikoku Electronics Co., Ltd. (PSEC)

(21) Appl. No.: 12/251,246

(22) Filed: Oct. 14, 2008

Related U.S. Application Data
(60) Provisional application No. 60/980,004, filed on Oct. 15, 2007.

(51) Int. Cl. G01L 25/00; G01L 3/00; G06F 19/00

(52) U.S. Cl. 702/105; 73/862.08; 702/41

(57) ABSTRACT

Methods, apparatuses and systems directed to calculation of a reel motor torque constant (“K_{T}”). In one implementation, calibration logic energizes supply and take-up reel motors to wind tape from a supply reel to a take-up reel. The calibration logic, during winding, selectively disengages the supply reel motor and measures one or more attributes of the supply reel motor, such as the resulting voltage observed at the winding terminals of the supply reel motor and the angular velocity of the supply reel motor during the period of disengagement. The calibration logic then calculates K_{T} based on the observed attributes.

### CROSS-REFERENCE TO RELATED APPLICATION

The present applications claims priority to U.S. Provisional Appl. Ser. No. 60/980,004 filed Oct. 15, 2007.

### TECHNICAL FIELD

The present disclosure generally relates to tape drives and more specifically to torque calibration of tape drive reel motors.

### BACKGROUND

Tape drives typically employ a cartridge reel motor and a drive reel motor to wind tape from a cartridge reel, in a tape cartridge, to a drive reel, in the tape drive, and back. During winding of tape from either of the cartridge reel or the drive reel, the supply reel, that is, the reel from which tape is winding off from, ought to maintain an appropriate amount of tension in the tape such that the winding process can be performed without the tape getting tangled in tape drive parts. In addition, various tape format specifications call out tension values to be applied to the tape during read and write operations.

The tension applied to the tape via the supply reel is typically controlled by a corresponding supply reel motor applying torque. Application of the torque is generally done via torque control functions that can be implemented in tape drive control algorithms. The torque control functions are typically optimized based on the reel motor's torque constant which is sometimes referred to as “K_{T}.” K_{T} may additionally be utilized in the operations of loading a tape cartridge, reel motor velocity control loops and reel motor position control loops.

For a given manufacturer's line of reel motors, however, K_{T} may vary from an ideal value from one reel motor to the next. This situation disadvantageously can result in a non-ideal amount of torque being applied by a reel motor which in turn translates to non-optimal tape drive performance.

### SUMMARY

The present invention, in particular embodiments, is directed to methods, apparatuses and systems directed to calculation of a reel motor torque constant (“K_{T}”). In one implementation, calibration logic energizes supply and take-up reel motors to wind tape from a supply reel to a take-up reel. The calibration logic, during winding, selectively disengages the supply reel motor and measures one or more attributes of the supply reel motor, such as the resulting voltage observed at the winding terminals of the supply reel motor and the angular velocity of the supply reel motor during the period of disengagement. The calibration logic then calculates K_{T} based on the observed attributes.

The following embodiments and aspects thereof are described and illustrated in conjunction with systems, apparatuses and methods which are meant to be exemplary and illustrative, not limiting in scope. In various embodiments, one or more of the above-described problems have been reduced or eliminated. In addition to the aspects and embodiments described above, further aspects and embodiments will become apparent by reference to the drawings and by study of the following descriptions.

### BRIEF DESCRIPTION OF THE DRAWINGS

Example embodiments are illustrated in referenced figures of the drawings. It is intended that the embodiments and figures disclosed herein are to be considered illustrative rather than limiting.

FIG. 1 is a perspective view of an LTO-type magnetic tape cartridge as viewed from an upper side thereof;

FIG. 2 is another perspective view of the magnetic tape cartridge, showing the lower side thereof;

FIG. 3 is a perspective view of a magnetic tape drive, showing the external appearance thereof;

FIG. 4 is a perspective view schematically showing the internal configuration of the magnetic tape drive;

FIG. 5 is another perspective view of the internal configuration shown in FIG. 4 as viewed from the lower side thereof;

FIG. 6 is a diagram illustrating a tape threading mechanism;

FIG. 7 is a flowchart diagram illustrating a method for measuring supply reel motor parameters used to calculate a reel motor torque constant, in accordance with an example embodiment;

FIG. 8 is a flowchart diagram further illustrating certain operations of the method of FIG. 7, in accordance with an example embodiment;

FIG. 9 is a flowchart diagram further illustrating a supply reel motor coast operation of the method of FIG. 7, in accordance with an example embodiment;

FIG. 10 is a flowchart diagram further illustrating a supply reel motor spin to end of tape operation of the method of FIG. 7, in accordance with an example embodiment;

FIG. 11 is a diagram illustrating calculation of a reel motor torque constant based on the measured parameters from the method of FIG. 8, in accordance with an example embodiment; and

FIG. 12 is a schematic diagram illustrating an example computing system architecture that may be used to implement portions of the claimed embodiments.

### DETAILED DESCRIPTION

The following embodiments and aspects thereof are described and illustrated in conjunction with systems, apparatuses and methods which are meant to be illustrative, not limiting in scope.

Aspects of the claimed embodiments are directed to calculation of a reel motor torque constant (“K_{T}”). In one implementation, while a cartridge is in a tape drive, calibration logic energizes supply and take-up reel motors to wind tape from a supply reel to a take-up reel. The calibration logic then selectively disengages the supply reel motor and measures parameters of the supply reel motor. The calibration logic then calculates K_{T} based on the measured parameters. The resulting torque constant may be stored in the tape drive logic for use by logic and processes of the tape drive, such as tension control algorithms and the like.

For the K_{T} measurement while a supply reel motor is not actively powered-up but still being rotated by pull of tape from a take-up reel and associated motor, rotation of the supply reel motor acts as a generator resulting in a sinusoidal voltage at the supply reel motor winding terminals. The magnitude of this sinusoidal voltage is proportional to the K_{T} of the supply reel motor. This is due to the relationship of the magnets inside the supply reel motor moving by the winding in the motor. The magnetic field from the magnets is seen by the winding, changes in magnitude and polarity as the winding moves past the series of magnets. When the winding “sees” a change in the magnetic field, a current is induced in the winding. When the supply reel motor is “off,” the motor winding terminal voltages are not being driven by an external circuit and voltage on the terminals can be observed and that voltage is generated by the magnetically induced current in the winding. Since the supply reel motor is off but rotating, the current generated in the windings raises the voltage at the winding terminal. As the winding rotates by the series of magnets the voltage seen at the winding terminal will sinusoidally change from a positive voltage to a negative voltage and so on, until the supply reel motor stops rotating.

It should be understood that the claimed embodiments can be applied to both reel motors (cartridge reel and drive reel motors) of a typical tape drive in that measurements are recorded for both of the reel motors. Due to this, two K_{T} values can be produced—one for each reel motor and a particular K_{T} value will be applied to the applicable reel motor that was utilized to generate that particular K_{T} value.

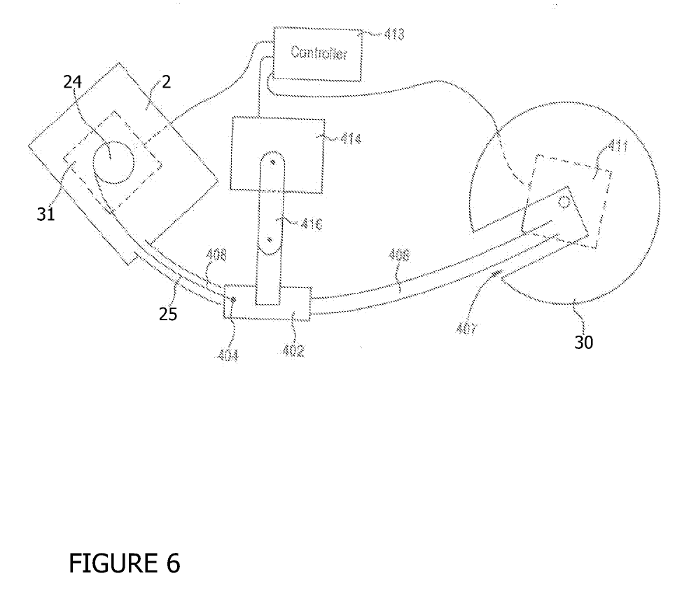

Calibration logic may be implemented as tape drive firmware utilizing example architecture 461 of FIG. 13. Additionally, the tape drive firmware may be implemented as a portion of a tape drive controller such as controller 413 of FIG. 6 which controls, amongst other operations, operation of various drive motors such as the reel motors. Controller 413 may also be implemented in architecture 461 of FIG. 13.

In another implementation, the calibration logic may be embodied as a client system that utilizes architecture 451, the calibration logic of the client system in turn operable to perform the claimed embodiments on a tape drive.

The parameters measured by the calibration logic, in one implementation, are back electromotive force (“BEMF”) voltage across windings of the supply reel motor and angular velocity of the reel motor during a measurement period which can also be referred to as revolutions-per-minute (“RPM”) and, as previously mentioned, are used in the K_{T} calculation. K_{T} may then be utilized as an adjustment factor for various torque control functions utilized by reel motor and tape control algorithms.

In one implementation, calibration logic energizes reel motors of a tape drive to wind tape, from a supply reel to a take-up reel, with low tape tension in order to minimize perturbations to the tape tension and take-up reel loop. This involves the calibration logic energizing the reel motors to achieve a desired tape speed and provide a tape speed stabilization period once a desired tape speed is reached. Next, the calibration logic lowers the supply reel tension, via application of torque by the supply reel motor, at a first rate to a target level. Once the supply reel tension reaches the target level, the calibration logic further lowers supply reel tension at a second rate until the supply reel tension is approximately zero (0) Newtons.

At approximately zero Newtons, the supply reel motor is effectively disengaged and is coasting. Restated, the supply reel and supply reel motor continue to revolve due to tension in the tape from the take-up reel and the take-up reel motor. Once the supply reel motor is disengaged, the calibration logic provides a stabilization period and then measures the supply-reel parameters.

In one implementation, the supply reel motor is disengaged for one revolution and the reel motor parameters are measured during pre-defined time intervals spanning the one revolution.

In another implementation, measurements are taken for a portion of a revolution and the calibration logic sets the tape speed to the desired level when the first portion of measurements have been completed, provides a stabilization period, lowers the supply reel tension to the target level at the first rate and further lowers the supply reel tension to approximately zero Newtons at the second rate. In turn, the calibration logic measures the reel motor parameters for another portion of the revolution. The calibration logic repeats the cycle until a full revolution of measurements have been made. Advantageously, this implementation reduces variation in the measurements due to angular positioning of the reel motor. The reduction in variation is due to repeatable variations in magnet strength and spacing variations over a full revolution of a motor.

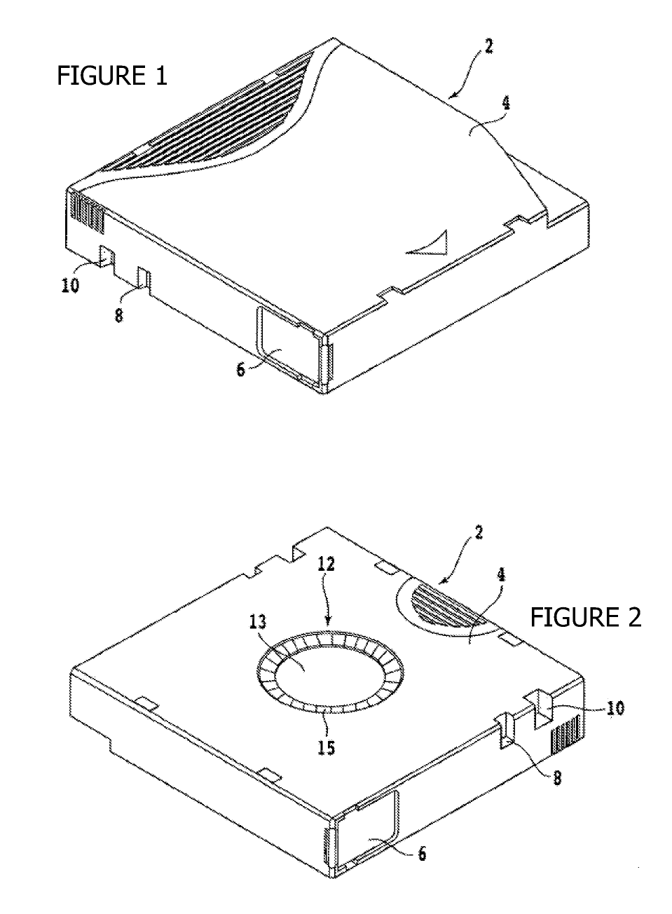

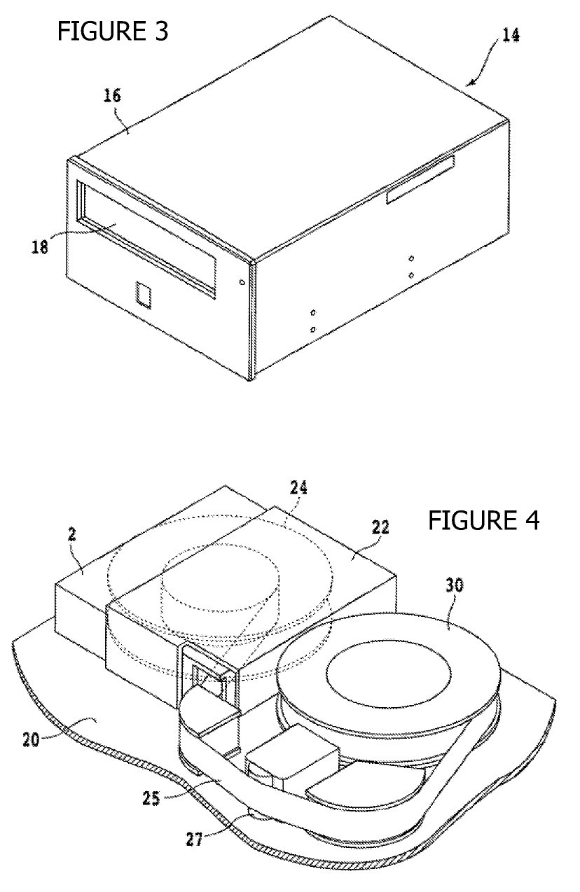

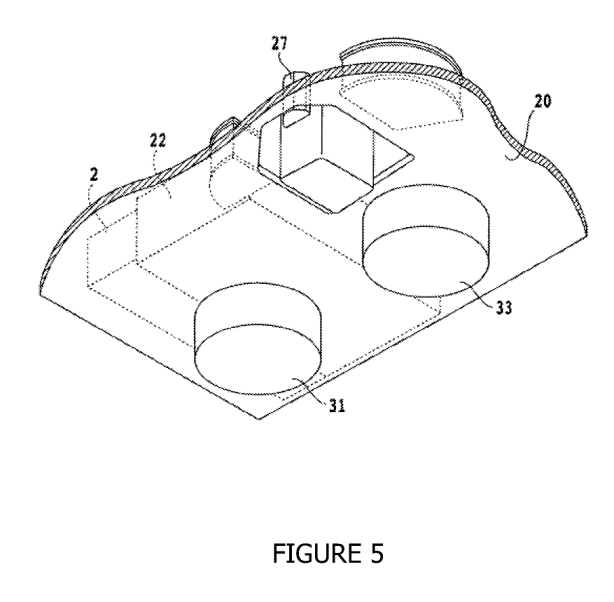

Before the claimed embodiments are explained in detail, FIGS. 1-6 will first be presented which generally describe a tape cartridge (FIGS. 1-2), a tape drive enclosure (FIG. 3) and reel motors situated in the tape drive enclosure and how they interact with a cartridge reel and a drive reel to wind tape to and from the cartridge (FIGS. 4-5). Additionally, an example mechanism for threading the tape from the cartridge reel to the drive reel will also be presented via FIG. 6.

Beginning with FIGS. 1-2, FIG. 1 is a perspective view of an LTO-type magnetic tape cartridge 2 and FIG. 2 is another perspective view of the magnetic tape cartridge 2 that shows the lower side. The magnetic tape cartridge 2 has a cartridge casing 4 accommodating a magnetic tape wound around a cartridge reel. The magnetic tape cartridge 2 has one side surface formed at its front end with a shutter (lid) 6 normally biased in its closing direction. This one side surface of the magnetic tape cartridge 2 is further formed with two notches 8 and 10 exposed to the lower surface of the magnetic tape cartridge 2. As shown in FIG. 2, the magnetic tape cartridge 2 has a chucking mechanism 12 composed of a magnetic member 13 such as an iron member and an annular gear 15. The chucking mechanism 12 is connected to the cartridge reel accommodated in the cartridge casing 4.

FIG. 3 is an external perspective view of a magnetic tape drive 14, and FIG. 4 is an internal perspective view schematically showing the internal configuration of the magnetic tape drive 14. FIG. 5 is another perspective view of the internal configuration shown in FIG. 4 as viewed from the lower side. As shown in FIG. 3, the magnetic tape drive 14 has a housing 16 whose front end surface is formed with a cartridge loading slot (insertion slot) 18. Referring to FIGS. 4 and 5, a cartridge reel motor 31, a drive reel motor 33, and a magnetic head 27 for recording and reproducing data are mounted on a base 20 provided in the tape drive 14.

As shown in FIGS. 4 and 5, the magnetic tape cartridge 2 is adapted to be inserted into a carrier 22 movably provided in the tape drive 14. A magnetic tape 25 is adapted to be supplied from a cartridge reel 24 provided in the magnetic tape cartridge 2, next moving past the magnetic head 27, and then being taken up by a drive reel 30 provided in the tape drive 14. The condition shown in FIGS. 4 and 5 is a condition where the carrier 22 holding the magnetic tape cartridge 2 has been moved to a cartridge mounting position and the chucking mechanism 12 connected to the cartridge reel 24 in the magnetic tape cartridge 2 is chucked (engaged) to a chucking mechanism of the cartridge reel motor 31 in the tape drive 14. The drive reel 30 is rotated by the drive reel motor 33.

FIG. 6 is a diagram illustrating a tape threading mechanism. A hub filler 402 is shown riding along the guide rail 408, with tape 25 attached. The end of the tape 25 is fixedly attached to a leader in pin 404, which is releasably attached to the hub filler 402. The other end of the tape 25 is wound around the cartridge reel 24 of cartridge 4. The cartridge reel 24 is mechanically coupled to the cartridge reel motor 412. The cartridge reel motor 412 rotates during a tape unloading operation to retract the tape 25 into the tape cartridge 2.

During a tape loading operation, the hub filler 402 attaches to the leader pin 404 in the tape cartridge 2. The hub filler 402 is then driven to the drive reel 30 by a guide arm 416 and a guide arm motor 414 along a guide rail 408. As the hub filler 402 is transported to the take-up reel 410, tape 25 is dragged out of the cartridge 2. The hub filler 402 then attaches to the drive reel 30, attaching the tape 25 to the drive reel 30. The hub filler 402 then attaches to the drive reel 30 at a drive reel opening 407. The drive reel 30 and the hub filler 402 are designed such that when the tape 25 is attached to the drive reel 30, the drive reel 30 can be rotated by a drive reel motor 33 to wrap or unwrap tape 25 around the drive reel 30 during a read/write operation.

During the tape read/write operation, the hub filler 402, leader pin 404 and tape 25 are attached to the drive reel 30. The drive reel 30 and the cartridge reel 24 are rotated to run the tape across a read/write head (not shown) for exchange of data between the tape drive mechanism and the tape 25. During the tape unloading operation, the hub filler 402, leader pin 404, are transported from the drive reel 30 along the guide rail 408 to the cartridge 2. Upon the hub filler 402 and the leader pin 404 being retracted into the cartridge 2, the leader pin 404 is detached from the hub filler 402.

The cartridge reel motor 31, guide arm motor 414 and the drive reel motor 33 are typically electrical motors controlled by a controller 413 during the loading, read/write and unloading operations. The controller 413 provides electrical power and/or control signals to these motors (31, 33, 414) to control the magnitude and direction of the motor movements. Different combinations of motor movements are used during the different operations. For instance, during a loading operation, the guide arm motor 414 may be induced to cause the guide arm 416 to drive the hub filler 402 to the drive reel 30.

As mentioned in the background section, a reel from which tape is unwinding can be referred to as a supply reel while the reel to which the tape is being fed can be referred to as a take-up reel. With that in mind, it should be understood in view of the claimed embodiments, that the cartridge reel 24 can be a supply reel when tape is wound from the cartridge reel 24 to the drive reel 30. Or, when tape is being wound from the drive reel 30 to the cartridge reel 24, then the drive reel 30 can be termed as the supply reel and the cartridge reel 24 can be referred to as the take-up reel.

In a similar manner, cartridge and drive reel motors (31, 33) can also be alternately-named depending on the direction of tape travel. For example, when the cartridge reel 24 is functioning as a supply reel, the cartridge reel motor 31 can then be labeled as a supply reel motor and the drive reel motor 33 can be named a take-up reel motor. As in the above-stated reel examples, the reel motor naming can also be reversed when the drive reel motor 33 is driving the drive reel 30 to supply tape to the cartridge reel 24 which is being turned by the cartridge reel motor 31.

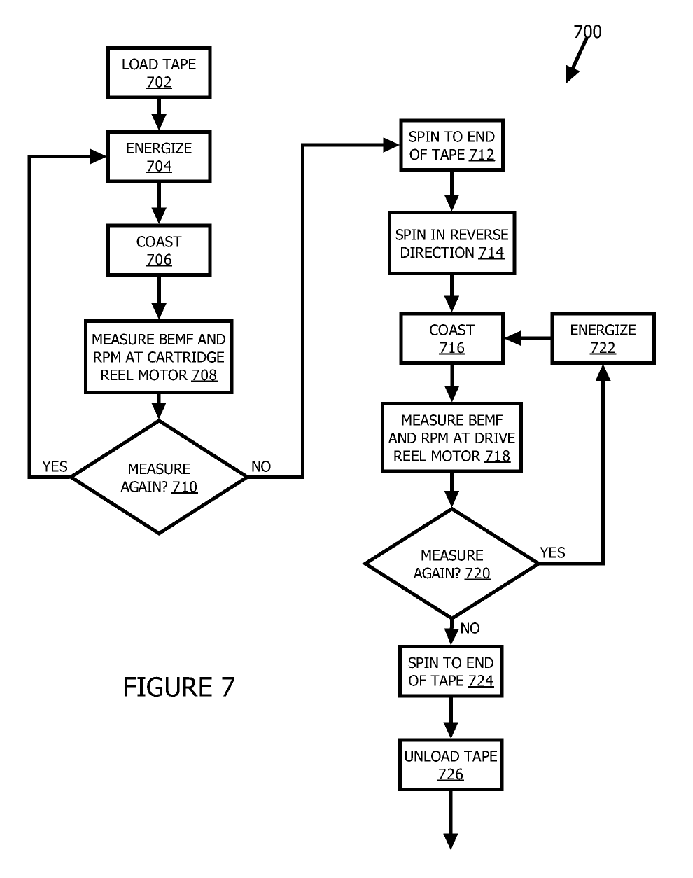

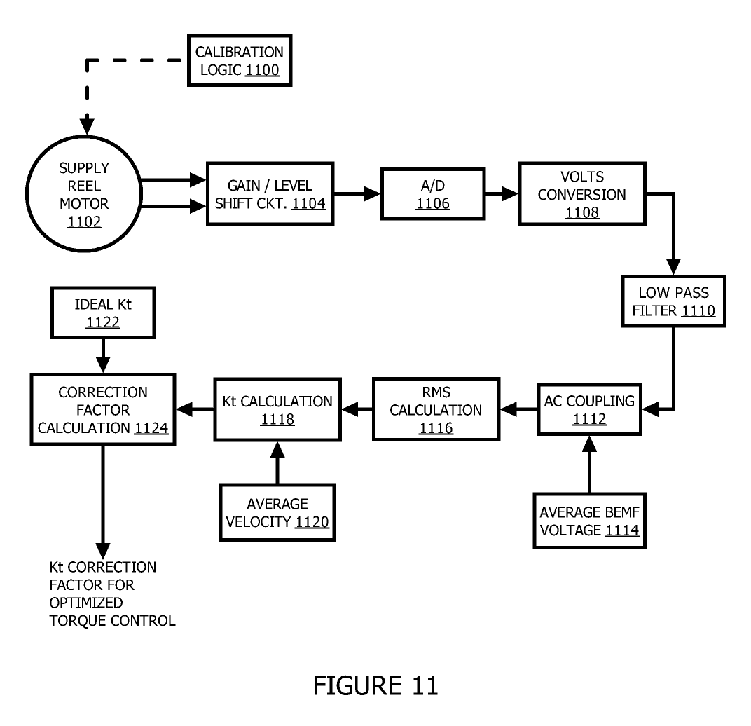

The claimed embodiments will now be further detailed via the flowcharts of FIGS. 7-10. Additionally, calculation of K_{T} will be described via FIG. 11.

FIG. 7 is a flowchart diagram illustrating a method 700 for measuring supply reel motor parameters used to calculate a reel motor torque constant, in accordance with an example embodiment. Method 700 describes a particular implementation wherein a tape cartridge 2 is inserted into a drive 14, calibration logic measures cartridge reel motor parameters, of cartridge reel motor 31, as tape 25 is wound from cartridge reel 24 to drive reel 30, when the cartridge reel motor 31 is selectively disengaged. Once measurements are completed for the cartridge reel motor 31, the calibration logic spins a balance of the tape 25 onto the drive reel rotor 35 and the process is repeated in the reverse direction—calibration logic measures drive reel parameters (BEMF voltage and RPM) while the tape 25 is spun to the cartridge reel 24 during the intervals when the drive reel motor 31 is disengaged.

Upon loading (702) of a tape 2 into a tape drive 14, the control logic initiates spinning (704) of the tape 2 from the cartridge reel 24 to the drive reel 30. The calibration logic then disengages the cartridge reel motor 31 thus allowing it to coast (706) as it is being rotated by the cartridge reel 24 due to the tape being pulled by the drive rotor 30, via the drive rotor 33. The calibration logic then disengages (706) the cartridge reel motor 31 and measures (708) voltage and RPM of the cartridge reel motor 31 while it is disengaged. Some methods of measuring RPM include using hall and optical sensors in a reel motor and measuring a radius of tape on a reel. If additional cartridge reel motor 31 measurements (710) are not required, the calibration logic spins (712) a remaining portion of tape 25 from the cartridge reel 24 to the drive reel 30. Otherwise, calibration logic repeats operations 704, 706 and 708.

As previously mentioned, measurement of the BEMF voltage and RPM can be done at time intervals during one revolution of a reel motor, in one implementation. In another implementation, operations 704-708 are performed during sub-revolutions and repeated until a full revolution of reel motor measurements are completed. Restated, the cartridge reel motor 31 is energized, disengaged and measurements are recorded—all three (energize, disengage and record measurements) repeatedly until measurements for a full revolution have been completed.

Once the tape 25 has been spun (712) to the drive reel rotor 30, control logic spins the tape (714) in the opposite direction from the drive reel rotor 30 to the cartridge reel rotor 24 and disengages (716) the drive reel motor 33. Calibration logic then records BEMF voltage and RPM (718) of the drive reel motor 33, during the intervals when the drive reel motor is disengaged. If additional measurements (720) are required, calibration logic energizes (722) the cartridge reel motor 31 and repeats operations 716 and 718 as necessary. Once measurements for the drive reel motor 33 are complete (720), the calibration logic spins (724) the tape back to the cartridge reel 24 and unloads the tape (726).

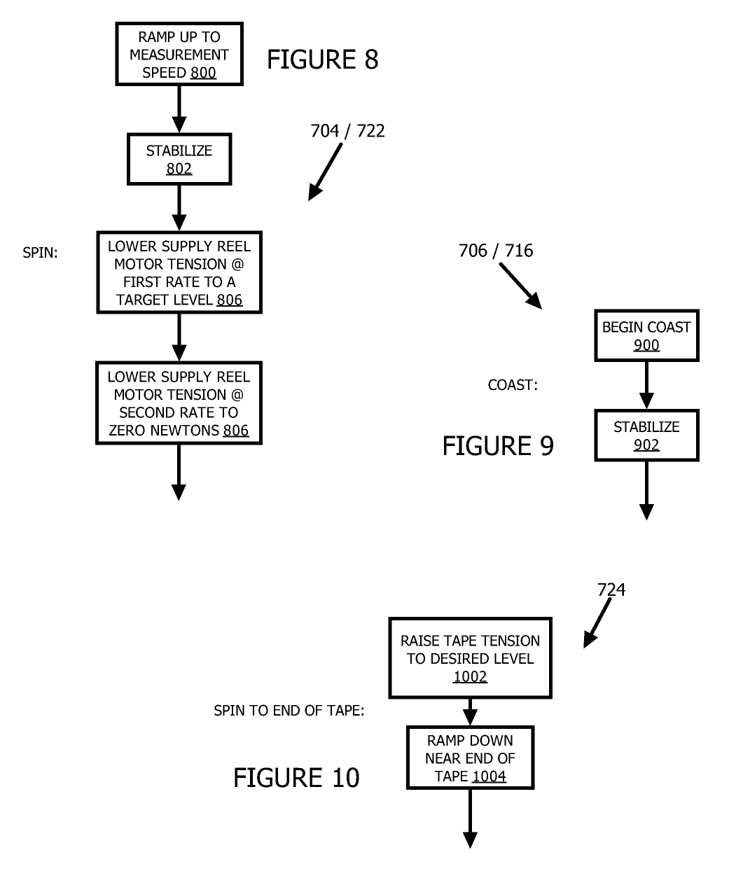

FIG. 8 is a flowchart diagram further illustrating operations 704 and 722 of FIG. 7. Operations 702 and 722 characterize, in some implementations, the process of energizing the reel motors, one of which is a supply reel motor, and then disengaging the supply reel motor. This process can be referred to as “selectively disengaging” the supply reel motor, in some implementations.

First, calibration logic ramps tape speed up to a target measurement speed (802) and allows the tape speed to stabilize for a period of time (802). Next, calibration logic lowers supply reel tension (804) at a first rate to a target level. The supply reel referred to in operation 804 may be the cartridge reel 24 in operation 704 or the drive reel 30 in operations 712 and 722. The calibration logic then lowers the supply reel tension (706) at a second rate until the reel motor (31 or 33 as applicable) is no longer engaged and applying approximately zero Newtons of torque.

One reason for ramping down the tension on the supply reel motor, in the fashion described via FIG. 8, is to prevent harm to the tape 726 by avoiding an abrupt transition in tape tension which may occur if the supply reel motor were to be quickly disengaged. In a similar manner, after measurements have been recorded on the supply reel motor, tape speed is ramped at an appropriate rate to the desired tape speed in order to prevent tape damage.

FIG. 9 is a flowchart diagram further illustrating the coast operations (706, 716) operations of FIG. 7. Once operation 806, of FIG. 8, is completed, calibration logic disengages the supply reel motor to allow it to coast (900) and implements a stabilization period (902).

FIG. 10 is a flowchart diagram further illustrating the spin to end of tape operation (724) of FIG. 7. Once the measurements of both reel motors (31, 33) have been completed, the calibration logic raises the tape tension to a desired level (1002) and ramps down the tape speed (1004) near the end of the tape 25, as viewed by the drive rotor 30, as the tape 25 is winding back into the cartridge 2.

FIG. 11 is a diagram illustrating calculation of a reel motor torque constant based on the measured parameters from the method of FIG. 7, in accordance with an example embodiment. Schematically represented is a supply reel motor 1102 that is selectively disengaged by control logic 1100 to allow for measurement of BEMF voltage and RPM. Once measurements are collected for a full revolution, the calibration logic processes the measurements through a gain/level shift circuit 1104, an analog-to-digital converter 1106 and the BEMF voltage measurements are further processed through volts conversion 1108. The calibration logic then processes the measurements through a low pass filter 1110, removes any DC bias in the measurement (1112) by subtracting the DC average of the average of the BEMF voltage measurements (1114) and calculates a root-mean-square of the measurements (1116). The calibration logic then uses the results 1118 of the root-mean-square 1116 and an average tape speed 1120, calculated from the collected RPM measurements, and an ideal torque constant 1122 to calculate (1124) a torque constant correction factor.

In respect to specific portions of FIG. 11, the average BEMF voltage 1114 may be calculated via the following Equation I wherein “x” are the individual collected voltage measurements as processed up through the low pass filter 1110:

$${x}_{rms} = \sqrt{\frac{1}{N} {\sum }_{i = 1}^{N} {x}_{i}^{2}} = \sqrt{\frac{{x}_{1}^{2} + {x}_{2}^{2} + … + {x}_{N}^{2}}{N}} \qquad Equation I$$

Additionally, the K_{T} calculation 1118 may be calculated via Equation II:

$$Kt = \frac{rms BackEMF Voltage \times \sqrt{2} \times 0.955}{( Average Angular Velocity ) \times 2 Pi} \qquad Equation II$$

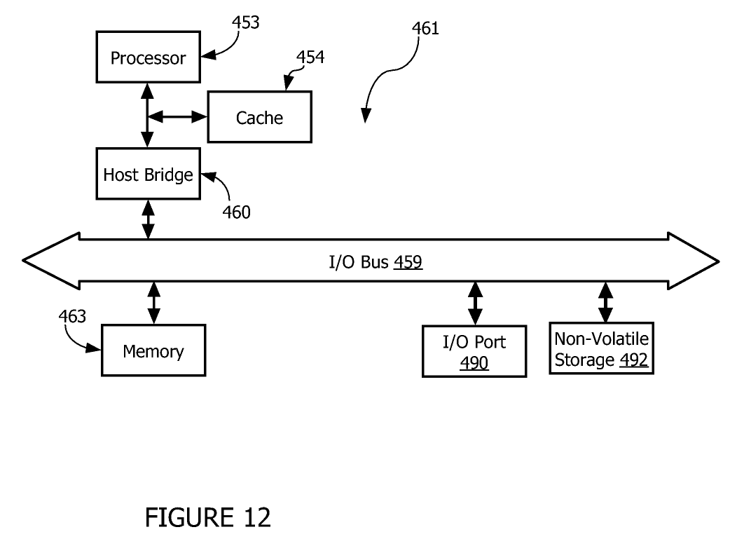

Calibration logic may be implemented, as part of a controller 413 in one implementation, in a tape drive firmware utilizing computer architecture such as the example architecture 461 of FIG. 12. Architecture 461 typically includes a processor 453, cache 454 and memory 463. Additionally, architecture 461 will typically include an I/O bus 459, I/O ports 490 and non-volatile storage 492 to store instructions that can be executed by processor 453.

In another implementation, the measurements performed on a supply reel motor may be directed by and collected by a host computer which can then perform the associate reel motor torque constant calculation.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method for determining a torque constant of a reel motor in a tape drive comprising:
energizing a supply reel motor and a take-up reel motor to wind tape from a supply reel to a take-up reel;
while the tape is winding:
selectively disengaging the supply reel motor; and
measuring one or more parameters of the supply reel motor, while the supply reel motor is disengaged; and
calculating the torque constant of the supply reel motor based on the measured parameters.

2. The method as recited in claim 1 wherein selectively disengaging the supply reel motor comprises:
setting tape speed to a target tape speed;
lowering supply reel motor tension at a first rate to a first target level;
lowering the supply reel motor tension at a second rate to about 0 Newtons.

3. The method as recited in claim 2 wherein the first rate is greater than the second rate.

4. The method as recited in claim 2 further comprising waiting a period of time before lowering the supply reel motor tension thereby allowing the tape speed to stabilize to the target tape speed.

5. The method as recited in claim 1 wherein the one or more parameters are back electromotive force (“BEMF”) voltage across windings of the supply reel motor and angular velocity of the supply reel motor.

6. The method as recited in claim 1 wherein the supply reel motor is a cartridge reel motor, the supply reel is a cartridge reel, the take-up reel motor is a drive reel motor and the take-up reel is a drive reel.

7. The method as recited in claim 6 wherein a leader pin of the tape drive is attached to the drive reel.

8. The method as recited in claim 1 wherein the supply reel motor is a drive reel motor, the supply reel is a drive reel, the take-up reel motor is a cartridge reel motor and the take-up reel is a cartridge reel.

9. The method as recited in claim 7 wherein a leader pin of the tape drive is attached to the drive reel.

10. A tape drive operative to determine a torque constant of a reel motor comprising:
a supply reel motor operative to rotate a supply reel;
a take-up reel motor operative to rotate a take-up reel;
calibration logic operative to:
energize a supply reel motor and a take-up reel motor to wind tape from a supply reel to a take-up reel;
while the tape is winding:
selectively disengage the supply reel motor; and
measure one or more parameters of the supply reel motor, while the supply reel motor is disengaged; and
calculate the torque constant based on the measured parameters.

11. The tape drive as recited in claim 10 wherein selectively disengage the supply reel motor comprises:
set tape speed to a target tape speed;
lower supply reel motor tension at a first rate to a first target level;
lower the supply reel motor tension at a second rate to about 0 Newtons.

12. The tape drive as recited in claim 11 wherein the first rate is greater than the second rate.

13. The tape drive as recited in claim 10 wherein the calibration logic is further operative to wait a period of time before lowering the supply reel motor tension thereby allowing the tape speed to stabilize to the target tape speed.

14. The tape drive as recited in claim 10 wherein the parameters are BEMF voltage across windings of the supply reel motor and angular velocity of the supply reel motor.

15. The tape drive as recited in claim 10 wherein the supply reel motor is a cartridge reel motor, the supply reel is a cartridge reel, the take-up reel motor is a drive reel motor and the take-up reel is a drive reel.

16. The tape drive as recited in claim 15 wherein a leader pin of the tape drive is attached to the drive reel.

17. The tape drive as recited in claim 10 wherein the supply reel motor is a drive reel motor, the supply reel is a drive reel, the take-up reel motor is a cartridge reel motor and the take-up reel is a cartridge reel.

18. The tape drive as recited in claim 17 wherein a leader pin of the tape drive is attached to the drive reel.

19. A computer-readable medium storing executable instructions to calibrate torque of a supply reel motor in a tape drive, the executable instructions which, when executed, is operable to cause one or more processors to:
energize a supply reel motor and a take-up reel motor to wind tape from a supply reel to a take-up reel;
while the tape is winding:
selectively disengage the supply reel motor; and
measure one or more parameters of the supply reel motor, while the supply reel motor is disengaged; and
calculate the torque constant of the supply reel motor based on the measured parameters.

20. The computer-readable medium as recited in claim 19 wherein selectively disengage the supply reel motor comprises:
set tape speed to a target tape speed;
lower supply reel motor tension at a first rate to a first target level;
lower the supply reel motor tension at a second rate to about 0 Newtons.

21. The computer-readable medium as recited in claim 20 wherein the first rate is greater than the second rate.

22. The computer-readable medium as recited in claim 10 wherein the executable instructions which, when executed, is operable to cause one or more processors to wait a period of time before lowering the supply reel motor tension thereby allowing the tape speed to stabilize to the target tape speed.
